(19) United States
(12) Patent Application Publication
(10) Pub. No.: US 2020/0034828 A1
(43) Pub. Date: Jan. 30, 2020

(54) METHOD AND SYSTEM FOR DIGITAL CURRENCY GENERATION AND MANAGING

(71) Applicant: LIBRA INSURANCE COMPANY LTD, Holon (IL)

(72) Inventor: Etti Elishkov, Holon (IL)

(73) Assignee: LIBRA INSURANCE COMPANY LTD, Holon (IL)

(21) Appl. No.: 16/520,074

(22) Filed: Jul. 23, 2019

Related U.S. Application Data
(60) Provisional application No. 62/702,961, filed on Jul. 25, 2018.

(51) Int. Cl. G06Q 20/36; G06Q 40/08; G06Q 40/04

(52) U.S. Cl. CPC G06Q 20/3672; G06Q 40/04; G06Q 40/08; G06Q 20/3678

(57) ABSTRACT

The present invention provides a system that is configured to operate as a platform which enables users to online purchase from a digital insurance-based company one or more products, e.g., such as an insurance policy, and accordingly to create for each purchased product a corresponding amount of digital currency.

### CROSS REFERENCE TO RELATED APPLICATION

This application claims priority to U.S. Provisional Patent Application No. 62/702,961, filed on Jul. 25, 2018 entitled “METHOD AND SYSTEM FOR DIGITAL CURRENCY GENERATION AND MANAGING”, which is incorporated herein by reference in its entirety for all purposes.

### FIELD OF THE INVENTION

The present invention relates to the field of digital currency. More particularly, the invention relates to a method and system for creating, managing and distributing of digital currency, in particular in conjunction with insurance-based company and its line of products.

### BACKGROUND OF THE INVENTION

As more users are connected to an online network, such as the Internet, the usages of digital currencies have been increased and become very popular among users. In general, digital or virtual currency is a type of unregulated, digital money, which is issued and usually controlled by its developers and used among the members of a specific virtual community. Digital currencies may expose traditional trading markets into novel and advantageous trading environments with enhance benefit for the users of the virtual community.

It is an object of the present invention to provide a technological system which is capable of creating, managing and distributing digital currency for users that purchase one or more insurance-based products.

It is another object of the present invention to provide a system which is capable of linking digital currency with a stock exchange.

Other objects and advantages of the invention will become apparent as the description proceeds.

### SUMMARY OF THE INVENTION

A method of generating and managing digital currency, comprising:
a) obtaining data relative to at least one purchased product or service;
b) generating digital currency in accordance with said obtained data; and
c) crediting a digital wallet of a user with said generated digital currency.

According to an embodiment of the invention, the method further comprises enabling a user to use the digital currency via the digital wallet.

According to an embodiment of the invention, the digital wallet is used to save and transfer digital currency, withdraw cash, use the digital currency for purchasing one or more products/services at 3rd party that except the digital currency, and renew or update an existing purchased product/service or purchase an additional product/service.

According to an embodiment of the invention, the method further comprises linking the digital currency to a stock exchange market, e.g., in terms of stock financial value by “Fiat Money”.

According to an embodiment of the invention, the linking of the digital currency to the stock exchange market comprises: a) receiving data relative to the value of a stock exchange associated with a product/service provider through which the digital currency is being generated; and b) updating the value of said digital currency according to said received data.

According to an embodiment of the invention, the generation of the digital currency is provided in an encrypted manner.

According to an embodiment of the invention, the obtained data comprises a unique identification (ID) of at least one purchased product/service, a unique ID of the user who purchased said at least one product/service, timestamping and the value/cost of said at least one purchased product/service.

According to an embodiment of the invention, the unique identification (ID) of the at least one purchased product/service is an insurance policy number.

According to an embodiment of the invention, the at least one purchased product/service is an insurance-based product, in particular an insurance policy.

According to an embodiment of the invention, each digital wallet is associated with a specific individual user.

In another aspect, a system of generating and managing digital currency, comprising:
a) at least one processor; and
b) a memory comprising computer-readable instructions which when executed by the at least one processor causes the processor to execute a clearinghouse server, wherein the server:
   i. obtains data relative to at least one purchased product or service;
   ii. generates digital currency in accordance with said obtained data;
   iii. credits a digital wallet of a user with said generated digital currency; and
   iv. enables to use and transfer the digital currency via the digital wallet.

According to an embodiment of the invention, the clearinghouse server further configured to link the digital currency to a stock exchange market information feed, thereby enabling to update the value of the digital currency to the actual stock exchange.

In yet another aspect, a non-transitory computer-readable medium comprising instructions which when executed by at least one processor causes the processor to perform the method of the present invention.

### BRIEF DESCRIPTION OF THE DRAWINGS

In the drawings:

FIG. 1 schematically illustrates a system that is configured to be used as a technology platform for digital currency creation and managing, according to an embodiment of the invention; and

FIG. 2 is a flow chart generally illustrating the method of the invention.

### DETAILED DESCRIPTION OF THE INVENTION

Various terms are used throughout the description and the claims which should have conventional meanings to those with a pertinent understanding of computer programming. Additionally, various descriptive terms are used in describing the exemplary embodiments in order to facilitate an explanation of them, and to aid one's understanding. However, while the description to follow may entail terminology which is perhaps tailored to certain computing or programming environments, such as OAuth or OpenID Connect (OIDC), it will be appreciated by a person skilled in the art that such terminology is employed in a descriptive sense and not a limiting sense. Where a confined meaning of a term is intended, it will be explicitly set forth or otherwise apparent from the disclosure.

According to an embodiment of the invention, the present invention provides a system that is configured to operate as a platform which enables users to online purchase from a digital insurance-based company one or more products, e.g., such as an insurance policy, and accordingly to create for each purchased product a corresponding amount of digital currency. In addition, the platform may enable to establish products in an offline procedure. In such offline procedure, users that will purchase one or more insurance-based products from the company, they will be entitled to receive the digital currency from the company. The system adapted to manage the digital currencies and it enables users to use the digital currency via dedicated digital wallets. For example, each user may use its own personal digital wallet to trade with digital currency either within a virtual trade market associated with a specific virtual community, or with other environments (e.g., withdrawal money in the real world or using the aggregated value of the digital currency in a third party virtual environment).

Reference will now be made to several embodiments of the present invention, examples of which are illustrated in the accompanying figures for purposes of illustration only. One skilled in the art will readily recognize from the following description that alternative embodiments of the structures and methods illustrated herein may be employed without departing from the principles of claimed invention. The terms “Libra”, “Libra coin” or “Libra digital currency” refer interchangeably herein to a type of currency available in digital form that exhibits properties similar to physical currencies, but can allow for instantaneous transactions and borderless transfer-of-ownership. Like traditional money, the Libra currency may be used to buy physical goods and services, but may also be restricted to certain communities such as for use inside a platform which enables users to online purchase from a digital insurance-based company one or more products.

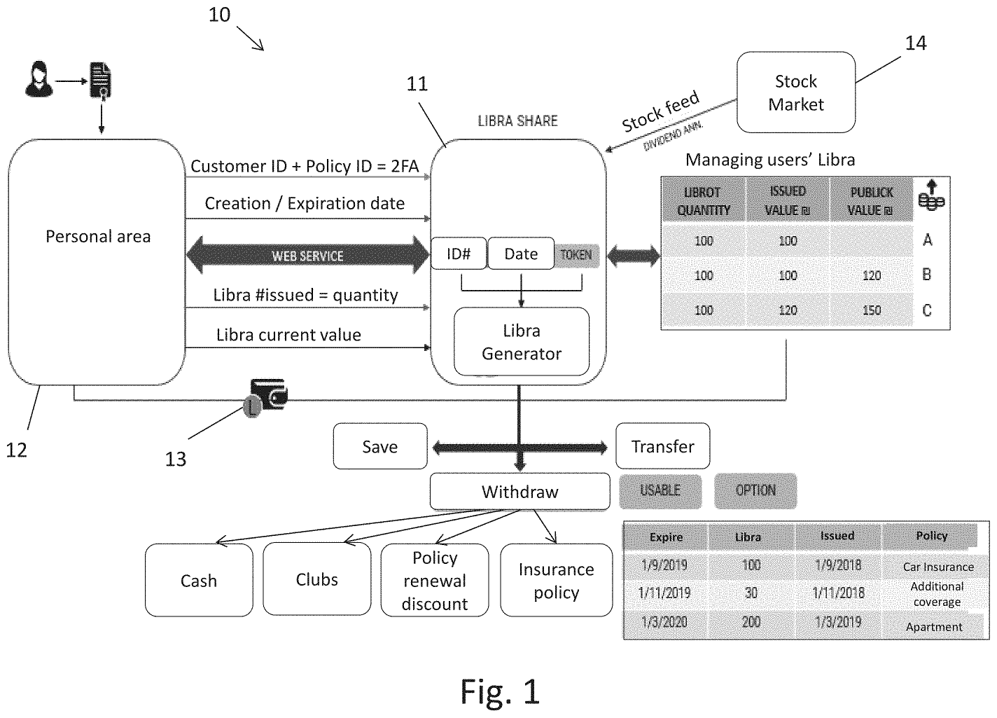

FIG. 1 schematically illustrates a system 10 for digital currency creation and managing, according to an embodiment of the invention. System 10 is configured to be used as a technology platform that comprises a server 11 for generating and managing digital currency, a user interface 12 (which can be defined also as a user's personal area) for enabling each user to access his/her online account in server 11 and a digital wallet 13 associated with each individual user of system 10.

Server 11 is associated with a stock exchange market 14 in order to link the value of the digital currency to a specific stock exchange, e.g., in terms of stock financial value by “Fiat Money” (the term “Fiat Money” refers herein to a currency without intrinsic value that has been established as money, often by government regulation. In other words, to a currency that a government has declared to be legal tender, but it is not backed by a physical commodity). For example, server 11 may receive data feeds relative to the specific stock exchange from market 14. In addition, server 11 is used as a clearinghouse that is configured to facilitate the exchange (i.e., clearance) of payments, securities, or derivatives transactions relative to the digital currency.

By being linked to the stock market, the current value of the digital currency (i.e., the “Libra” current value) can be updated according to the value of the stock exchange shares. According to an embodiment of the invention, server 11 continuously receives feeds from market 14 regarding the value of a stock exchange relative to the creator of the digital currency. For example, the creator of the digital currency can be an insurance company that provides a plurality of insurance-based products. According to the received feeds, server 11 may calculates the value of the digital currency, thus when the value of the share increases in market 14—the value of the digital currency may also increase, and vice versa.

A user may use the digital wallet 13 to trade with the digital currency that he/she has. For example, one may save the digital currency, withdraw the digital currency in order to receive cash, use the digital currency to purchase insurance products or to obtain discount, use the digital currency at third party entities (e.g., use it in an online shopping store), transfer Libra from one user to another (e.g., from a digital wallet of one user to a digital wallet of another user), etc. Digital wallet 13 is digital device that can provided in a plurality of suitable forms, e.g., in form of a dedicated application (e.g., for smartphones), an electronic card, barcode, or any other suitable form. According to an embodiment of the invention, each user may have a personal digital wallet 13 (e.g., in form of an electronic device or online service that stores aggregated amount of digital currency like Libra) which allows the user to make electronic transactions with Libra. This can include purchasing items on-line with a computer or using a smartphone to purchase something at a physical store. A user's bank account can also be linked to the digital wallet 13. According to some embodiment of the invention, the digital currency of the present invention can also be traded with other digital money or crypto currencies, and therefore it may store private keys for other cryptocurrencies like bitcoin.

According to an embodiment of the invention, the generation of the digital currency by platform 11 for each individual user may involve the following elements:
Unique identification (ID) for each generated digital currency. For example, the unique ID may comprise a user ID (e.g., customer ID) and a unique number of a purchased insurance product (e.g., insurance policy number or ID);
A timestamping which may include the creation time and/or expiration date of the digital currency. The timestamping applies for each generated Libra a unique dating ID with may also include an expiration date (i.e., the generated Libra may be used by a user for a limited period of time, e.g., one year, after which they expired and cannot be used anymore). Alternatively, at least some of the generated Libra may not include an expiration date; and
A token (digital currency) that reflects the quantity of the issued digital currency that is derived from the value of the purchased insurance product (i.e., the token reflects the number of issued “Libra”).

All the above will be better understood through the following illustrative and non-limitative examples.

For example, for an insurance product that cost 1000$ (e.g., a car insurance), a specific user that purchase such product may receive 10 Libra. In this example, the system generates a token that reflects 10 Libra units (i.e., 10 Libra) for this specific user, wherein the generation of the 10 Libra comprise the insurance policy number of the purchased insurance product, the customer ID of this specific user, creation and expiration dates of the Libra and the quantity of the issued digital currency (in this specific example, the quantity of the digital currency is equal to 1% of the total cost of the purchased insurance product). The quantity of the digital currency may change from one insurance product to another and/or form one user to another, and it may be influenced by the total cost each user may charge for each specific purchased insurance product (or bundle of products). For example, the percentage of the digital currency out of the total cost of the purchased insurance product can be varied (e.g., 1% to 10%), thus the higher the cost of a specific product—the higher the percentage of the digital currency that are derived from its cost. Optionally, at least for some insurance products, the quantity of the digital currency can be fixed (e.g., for insurance products that cost 400-800$, the quantity of the received digital currency is 5 Libra).

According to an embodiment of the invention, from security aspects the generation process of the digital currency (i.e., the Libra) may involve encoding and encryption that incorporates insurance policies elements, such as insurance policy number, user or customer ID, timestamping, etc. The encoding and encryption can be applied or implemented by using one or more exiting tools such as OpenID Connect or OAuth 2.0, which are configured to enable the generation of a unique encryption key that can be changed, e.g., according to predefined intervals.

Digital wallet 13 enables a user to communicate with server 11 (i.e., which act as a central clearinghouse) and to be identified, e.g., by using OAuth 2.0 authorization framework (according to RFC 6749 standard), in which identification can be used to know the amount of Libra each user has. For example, the OAuth 2.0 authorization framework enables digital wallet 13 to obtain limited access to an HTTP service, either on behalf of a resource owner by orchestrating an approval interaction between the resource owner and the HTTP service, or by allowing digital wallet 13 to obtain access on its own behalf.

FIG. 1 and the above discussion were intended to provide a brief, general description of a suitable computing environment for system 10 in which the invention may be implemented, e.g., as a web-oriented digital platform, mobile-oriented platform, or both web and mobile. While the invention is described in the general context of program modules or codes that execute in conjunction with an application program that runs on an operating system on server 11, those skilled in the art will recognize that the invention may also be implemented in combination with other program modules and/or other computer systems. The functions described herein may be performed by executable code and instructions stored in computer readable medium and running on one or more processor-based systems. Embodiments of the invention may be implemented as a modular platform that is based on micro-services, e.g., a computer system that encodes a computer program of instructions for executing the micro-services, thus each micro-service can be replaced by another in accordance with the system's needs.

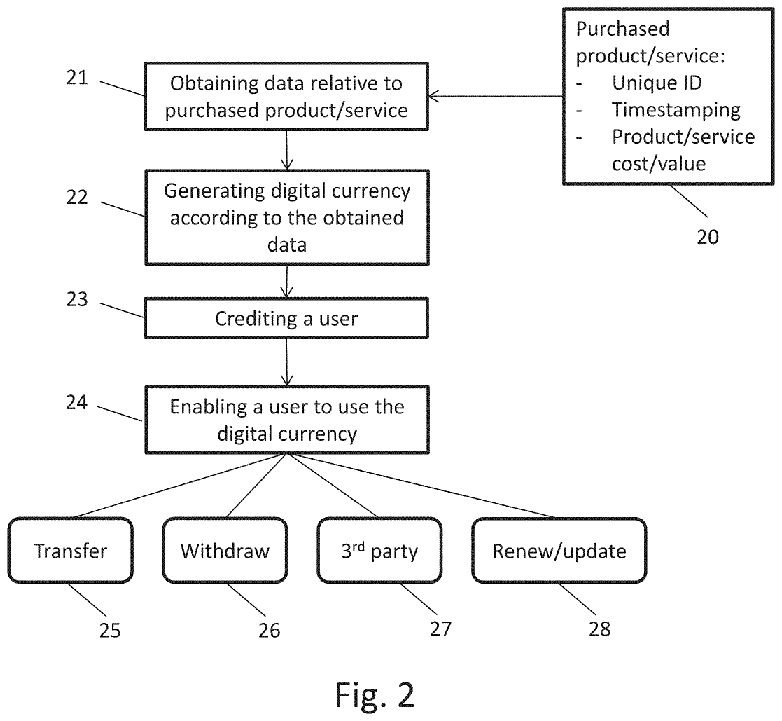

FIG. 2 is a flow chart generally illustrating a method of creating and managing digital currency, according to an embodiment of the invention.

When a user purchases an insurance-based product (e.g., a real estate insurance product, a car insurance product, etc.), the system of the present invention generates digital currency (i.e., Libra) in accordance with the cost of the purchased product and in an encryption manner that involves unique ID and timestamping, and stores the generated Libra in a digital wallet associated with the user.

The process of generating and managing the digital currency may involve the following steps:
Upon completion of purchasing a product or a service (bloc 20), obtaining data relative to at least one purchased product or service (bloc 21);
Generating digital currency in accordance with the obtained data (bloc 22);
Crediting a digital wallet of a user with the generated digital currency (bloc 23); and
Enabling the user to use the digital currency via the digital wallet (bloc 24). For example, a user may use the digital wallet to transfer digital currency, e.g., to another user's digital wallet (bloc 25), withdraw cash (bloc 26), e.g., to exchange at least some of the digital currency stored in the user's digital wallet into “real money” currency, to trade or purchase with the digital currency at any available 3^{rd} party products/services (bloc 27) that except the digital currency, renew or update an existing purchased product/service or purchase an additional product/service (bloc 28), etc.

The process of managing the digital currency may further involve the steps of:
Receiving data relative to the value of a stock exchange associated with a product/service provider through which the digital currency is being generated (e.g., the company that develop the digital currency); and
Updating the value of the digital currency according to the received data, thereby linking the value of the digital currency to the actual stock exchange.

As will be appreciated by the skilled person the arrangement described in the figures results in a system which is capable of creating and managing digital currency for users that purchase one or more insurance-based products.

The terms, “for example”, “e.g.”, “optionally”, as used herein, are intended to be used to introduce non-limiting examples. While certain references are made to certain example system components or services, other components and services can be used as well and/or the example components can be combined into fewer components and/or divided into further components.

All the above description and examples have been given for the purpose of illustration and are not intended to limit the invention in any way. Many different methods of creating a digital currency, electronic and logical elements can be employed, all without exceeding the scope of the invention.

1. A method of generating and managing digital currency, comprising:
a) obtaining data relative to at least one purchased product or service;
b) generating digital currency in accordance with said obtained data; and
c) crediting a digital wallet of a user with said generated digital currency.

2. A method according to claim 1, further comprising enabling a user to use the digital currency via the digital wallet.

3. A method according to claim 2, wherein the digital wallet is used to save and transfer digital currency, withdraw cash, use the digital currency for purchasing one or more products/services at 3rd party that except the digital currency, and renew or update an existing purchased product/service or purchase an additional product/service.

4. A method according to claim 1, further comprising linking the digital currency to a stock exchange market, in particular, in terms of stock financial value by “Fiat Money”.

5. A method according to claim 4, wherein the linking of the digital currency to the stock exchange market comprises:
a) receiving data relative to the value of a stock exchange associated with a product/service provider through which the digital currency is being generated; and
b) updating the value of said digital currency according to said received data.

6. A method according to claim 1, wherein the generation of the digital currency is provided in an encrypted manner.

7. A method according to claim 1, wherein the obtained data comprises a unique identification (ID) of at least one purchased product/service, a unique ID of the user who purchased said at least one product/service, timestamping and the value/cost of said at least one purchased product/service.

8. A method according to claim 7, wherein the unique identification (ID) of the at least one purchased product/service is an insurance policy number.

9. A method according to claim 1, wherein the at least one purchased product/service is an insurance-based product, in particular an insurance policy.

10. A method according to claim 1, wherein each digital wallet is associated with a specific individual user.

11. A system of generating and managing digital currency, comprising:
a) at least one processor; and
b) a memory comprising computer-readable instructions which when executed by the at least one processor causes the processor to execute a clearinghouse server, wherein the server:
I. obtains data relative to at least one purchased product or service;
II. generates digital currency in accordance with said obtained data;
III. credits a digital wallet of a user with said generated digital currency; and
IV. enables to use and transfer the digital currency via the digital wallet.

12. A system according to claim 11, wherein the clearinghouse server further configured to link the digital currency to a stock exchange market information feed, thereby enabling to update the value of the digital currency to the actual stock exchange.

13. A non-transitory computer-readable medium comprising instructions which when executed by at least one processor causes the processor to perform the method of claim 1.
